(19) United States
(12) Patent Application Publication
(10) Pub. No.: US 2016/0232804 A1
(43) Pub. Date: Aug. 11, 2016

(54) Fidget Sleeve

(71) Applicants: William James Nichols, Flora, IN (US); David Daniel Nichols, Flora, IN (US); Kevin Daniel May, Kokomo, IN (US); Joseph Nathanial Hackett, Kokomo, IN (US); Julia Ann May, Kokomo, IN (US); Martin Pike, Kokomo, IN (US); Rosemary Louise Saile Pike, Kokomo, IN (US)

(72) Inventors: William James Nichols, Flora, IN (US); David Daniel Nichols, Flora, IN (US); Kevin Daniel May, Kokomo, IN (US); Joseph Nathanial Hackett, Kokomo, IN (US); Julia Ann May, Kokomo, IN (US); Martin Pike, Kokomo, IN (US); Rosemary Louise Saile Pike, Kokomo, IN (US)

(21) Appl. No.: 14/614,537

(22) Filed: Feb. 5, 2015

(51) Int. Cl. G09B 19/00

(52) U.S. Cl. CPC G09B 19/00

(57) ABSTRACT

An elongate hollow tube having two or more fidgets molded onto or attached to an outside surface of said tube is described. The tube can be slipped over a smooth elongated base object, such as a pencil or similar object, to provide manipulatives for students.

BACKGROUND

(1) Technical Field

The disclosure relates to sensory manipulative tools, and more particularly, to a sleeve for mounting sensory manipulative tools onto an elongated base structure.

(2) Description of the Related Art

It has been discovered that people having issues such as Attention Deficit Hyperactivity Disorder (ADHD) can benefit in a school setting when they have a way to release their energy while engaged in the learning process. For example, if these students can keep their hands busy, they may be able to pay better attention to lectures or other learning situations than if their hands are not kept busy.

A variety of products are available for keeping hands busy, including stress balls, rubber bracelets, Silly Putty®, or the like. For example, U.S. Pat. No. 7,361,075 (Krull) discloses a hand-held amusement device. US Patent Application 2011/0281688 (Harris, Jr. et al) describes a manipulative device that is attached to a user's fingers and also can be attached to a pencil. US Patent Application 2009/0149698 (Tastard) shows a variety of sensory tools that can be removably attached to a weighted lap pillow.

### SUMMARY

A principal object of the present disclosure is to provide a sleeve that can slip over an elongated base structure, such as a standard pencil, wherein the sleeve comprises a variety of fidgets.

Another object is to provide a fidget sleeve having a variety of textures and manipulative actions thereon.

In accordance with the objects of this disclosure there is provided a sleeve having a variety of fidgets thereon wherein the sleeve can be slipped on and off an elongated base structure.

### BRIEF DESCRIPTION OF THE DRAWINGS

In the accompanying drawings forming a material part of this description, there is shown:

FIGS. 1-4 schematically represent several preferred embodiments of the present disclosure.

### DESCRIPTION OF THE PREFERRED EMBODIMENTS

The present disclosure provides a sleeve comprising a variety of fidgets or manipulatives. The sleeve is adapted to receive an elongate writing implement such as a pencil, including a wooden pencil or a mechanical pencil, or alternately, a pen, a stylus, or a non-writing implement having a similar elongated base shape of small diameter.

Arranged on the sleeve are two or more different types of fidgets. Students can manipulate the fidgets on the sleeve, expending energy by this constant movement, thus freeing their minds to concentrate on schoolwork.

Preferably, the fidgets can provide positive sensory feedback to the students. This can be useful for students with ADHD or other issues. The material of the fidgets can be such as to provide positive tactile and sensory input and may also provide a soothing or calming effect. Preferably, the material of the fidgets will be non-toxic, latex-free, and hypoallergenic. The fidgets may be formed in a variety of sizes, shapes, and colors and may be opaque or transparent. Any of the fidgets could be scented, for example, with a light fruity scent or peppermint or other herbal scent. Preferably, the fidgets will not make noise so as to not be distracting to other students in the classroom. The fidgets can relieve stress and promote attention to task.

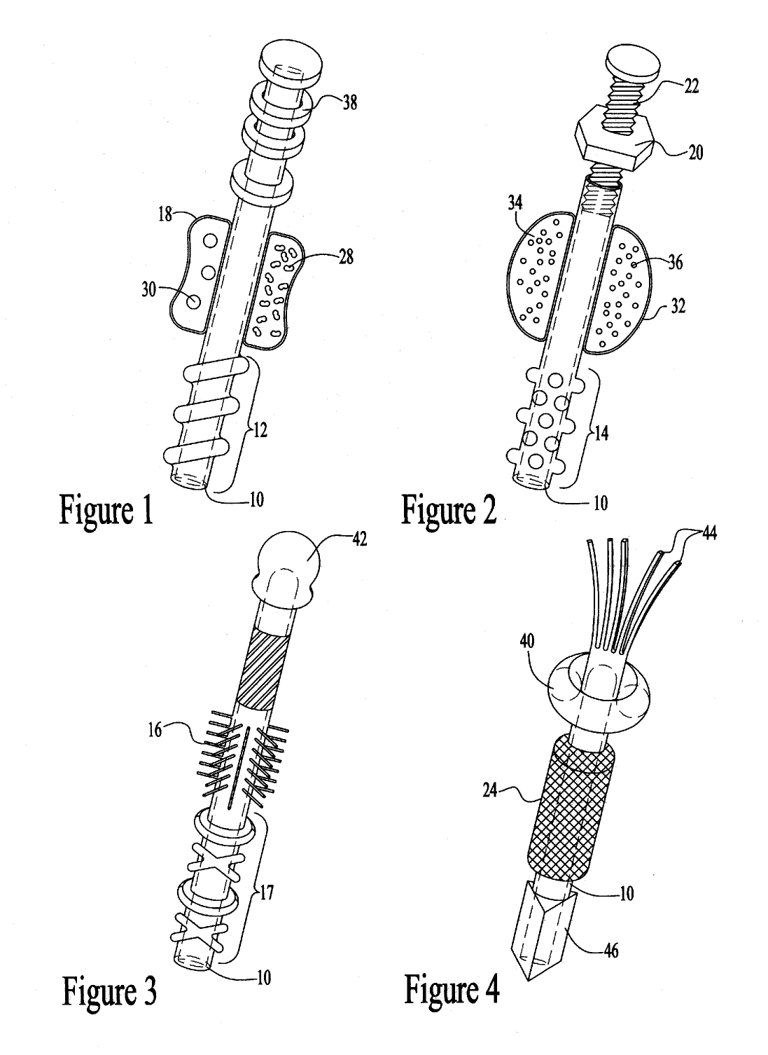

Referring now to the drawing FIGS. 1-4, it is noted that these drawings are examples only and are not drawn to scale. It should be understood that any of the fidgets in any of the drawings are interchangeable and that more or fewer fidgets can be provided on any one sleeve and in any order.

For example, the sleeve can be a tube 10 that can slip over a smooth elongated base structure (not shown) and remain in place, as shown in FIGS. 1-4. The elongated base structure may be a pencil, including a wooden pencil or a mechanical pencil, or alternately, a pen, a stylus, or a non-writing implement having a similar elongated base shape of small diameter. For example, some of the fidgets could be of a rubber-like material having a variety of textures. The material could have protrusions of various lengths. Some examples of these fidgets are 12 in FIG. 1, 14 in FIGS. 2, and 16 and 17 in FIG. 3.

Some aspects of certain fidgets can improve hand and finger function. For example, one of the fidgets may have a weighted component that provides sensory feedback in the writing process, such as 18 in FIG. 1. In another example, one of the fidgets may be a nut 20 that is turned on a screw 22, as shown in FIG. 2. As a student turns the nut up and down on the screw with a thumb, the hand muscles are exercised in such a way as to improve writing ability. The nut and screw can be of any shape. For example, the nut could be a wing nut or have the shape of an animal or vehicle, or any other interesting shape, including licensed characters, for example.

The fidgets must be durable enough so that they cannot be picked apart. Preferably, the fidgets can be molded into the sleeve in the manufacturing process. A variety of different types of fidgets having different textures and manipulative actions should be included on each sleeve. Also, since the sleeve can be easily slipped onto a pencil or similar base structure, one sleeve can be interchanged for another when a student tires of the first sleeve or as a reward for good work.

Some of the fidgets could be of fabric having textures such as smooth like satin or ridged like corduroy or any other pleasing texture. The fabric could be made in a tube shape to fit over the sleeve, such as 18 in FIG. 1 (shown in cross-section) or 24 in FIG. 4. The fabric tube could fit snugly against the sleeve and could be glued to the sleeve or held against the sleeve at either end by elastic, for example. Instead of fitting snugly against the sleeve, the fabric sleeve could have a foam-like material between it and the sleeve (24) or could have “beans” 28 such as in a bean bag or sand or the like between it and the sleeve. Alternately, a few beads 30 could be placed between the fabric and the sleeve. All of these examples provide different textures and manipulatives.

Another type of fidget could be a clear plastic material, such as 32 in FIG. 2 (shown in cross-section), having a gel-like substance 34 inside it so as to provide a moveable material when manipulated with the fingers. Small beads or glitter 36 could be provided within the gel-like substance. The plastic material should be strong enough to avoid breakage and the gel-like substance should be non-toxic.

A further type of fidget could be one that moves such as a ring (38 in FIG. 1) that can be spun in place and/or moved up and down on the sleeve. A gel-filled or rubber-type ring or protrusion (40 in FIG. 4) can be tapped noiselessly against a desk. A screw and nut combination (22, 20 in FIG. 2) wherein the nut can be spun up and down the screw is another example of a moveable fidget.

A chewable fidget could be attached to or molded onto the top of the sleeve, such as 42 in FIG. 3 or 44 in FIG. 4. The top side of the sleeve should be closed so that saliva does not drip onto the base structure. The sleeve with its fidgets should be easy to clean especially if a chewable fidget is to be used.

If the sleeve is used on a writing implement, it may be desirable to provide a pencil grip on the lower end of the sleeve. The grip, shown for example as 46 in FIG. 4, should be textured and shaped so as to facilitate holding the writing implement in a comfortable manner.

A wide variety of fidgets can be provided in any combination on several sleeves. as many as six or even more different fidgets can be provided on each sleeve. The sleeve can be removed easily for cleaning, sharpening the pencil, or changing to a different sleeve. The design includes a wide variety of textures, colors, shapes, and manipulations. The fidgets are designed so as not to make noise that would distract other students.

Although the preferred embodiment of the present disclosure has been illustrated, and that form has been described in detail, it will be readily understood by those skilled in the art that various modifications may be made therein without departing from the spirit of the disclosure and the scope of the appended claims.

What is claimed is:

1. A removable sleeve capable of being slipped over an elongated smooth base structure, comprising:
an elongate hollow tube having two or more fidgets molded onto or attached to an outside surface of said tube.

2. The removable sleeve according to claim 1 wherein said tube is closed at one end.

3. The removable sleeve according to claim 1 wherein said two or more fidgets have differing textures, colors, shapes, and/or manipulations.

4. The removable sleeve according to claim 2 wherein at least one of said fidgets is located on said outside surface of said tube at said closed end.

5. The removable sleeve according to claim 4 wherein said at least one of said fidgets is capable of being chewed.

6. The removable sleeve according to claim 1 wherein at least one of said fidgets comprises a rubber-like material having protrusions.

7. The removable sleeve according to claim 1 wherein at least one of said fidgets has a weighted component that provides sensory feedback in the writing process.

8. The removable sleeve according to claim 1 wherein at least one of said fidgets has a likeness of a nut turned on a screw.

9. The removable sleeve according to claim 1 wherein at least one of said fidgets comprises a fabric having a texture.

10. The removable sleeve according to claim 9 wherein a material is placed between said fabric and said sleeve and wherein said material is chosen from a group containing beans, beads, sand, gel, and foam.

11. The removable sleeve according to claim 1 wherein at least one of said fidgets comprises a clear plastic containing a gel-like substance.

12. The removable sleeve according to claim 11 wherein said gel-like substance contains glitter, beads, or other objects that can be manipulated.

13. The removable sleeve according to claim 1 wherein at least one of said fidgets is movable such as a ring that can be moved up and down and rotated on said sleeve or a nut that can be screwed up and down on a screw.

14. The removable sleeve according to claim 1 wherein at least one of said fidgets comprises a material that can be tapped noiselessly on a surface.

15. The removable sleeve according to claim 1 further comprising a pencil grip on a lower end of said sleeve.

16. The removable sleeve according to claim 1 wherein any of said fidgets may be scented.

17. The removable sleeve according to claim 1 wherein all of said fidgets are non-toxic and hypoallergenic.

18. The removable sleeve according to claim 1 wherein all of said fidgets are latex-free.
